(19) United States
(12) Patent Application Publication
(10) Pub. No.: US 2026/0222154 A1
(43) Pub. Date: Jul. 30, 2026

(54) METHODS AND APPARATUSES FOR S-SSB TRANSMISSION AND SL TRANSMISSION IN UNLICENSED SPECTRA

(71) Applicant: Lenovo (Beijing) Limited, Beijing (CN)

(72) Inventors: Xin Guo, Beijing (CN); Haipeng Lei, Beijing (CN); Zhennian Sun, Beijing (CN); Xiaodong Yu, Beijing (CN)

(73) Assignee: Lenovo (Beijing) Limited, Beijing (CN)

(21) Appl. No.: 19/143,761

(22) PCT Filed: Dec. 28, 2022
(86) PCT No.: PCT/CN2022/142789

§ 371 Date: Jun. 26, 2025

(51) Int. Cl. H04L 5/00; H04W 72/25

(52) U.S. Cl. CPC H04L 5/0053; H04W 72/25

(57) ABSTRACT

Embodiments of the present disclosure relate to methods and apparatuses for sidelink (SL) synchronization signal block (S-SSB) transmission and SL transmission in unlicensed spectra. According to an embodiment of the present disclosure, a user equipment (UE) can include: a transceiver, a processor coupled to the transceiver and configured to: obtain first configuration information for SL, wherein the first configuration information indicates at least one of the following: an interlace pattern; a set of interlaces for sidelink synchronization signal block (S-SSB) transmission; a set of interlace combinations for at least one of S-SSB transmission or SL transmission, wherein each interlace combination includes at least two interlaces; or a first plurality of resource blocks (RBs) for S-SSB repetitions in a frequency range, wherein the first plurality of RBs for S-SSB repetitions has a frequency spanning exceeding a predefined percentage of the frequency range; select resources within an RB set for transmitting at least one of S-SSB (s) or an SL transmission based on the first configuration information; and transmit, via the transceiver, at least one of the S-SSB (s) or the SL transmission on a set of resources within the selected resources in the case that the UE obtains an access opportunity to the RB set.

### TECHNICAL FIELD

Embodiments of the present application are related to wireless communication technologies, and more particularly, related to methods and apparatuses for sidelink (SL) synchronization signal block (S-SSB) transmission and SL transmission in unlicensed spectra.

### BACKGROUND

A sidelink is a long-term evolution (LTE) feature introduced in 3rd generation partnership project (3GPP) Release 12, and enables a direct communication between proximal user equipments (UEs), in which data does not need to go through a base station (BS) or a core network. A sidelink communication system has been introduced into 3GPP 5G wireless communication technology, in which a direct link between two UEs is called a sidelink.

Sidelink synchronization information is carried in an S-SSB. In an unlicensed spectrum, the S-SSB transmission and SL transmission may be multiplexed in some cases. Therefore, new designs for S-SSB transmission and SL transmission in unlicensed spectra are needed.

### SUMMARY OF THE APPLICATION

Embodiments of the present application at least provide a technical solution for S-SSB transmission and SL transmission in unlicensed spectra.

According to some embodiments of the present application, a UE may include: a transceiver; a processor coupled to the transceiver and configured to: obtain first configuration information for SL, wherein the first configuration information indicates at least one of the following: an interlace pattern; a set of interlaces for S-SSB transmission; a set of interlace combinations for at least one of S-SSB transmission or SL transmission, wherein each interlace combination includes at least two interlaces; or a first plurality of resource blocks (RBs) for S-SSB repetitions in a frequency range, wherein the first plurality of RBs for S-SSB repetitions has a frequency spanning exceeding a predefined percentage of the frequency range; select resources within an RB set for transmitting at least one of S-SSB(s) or an SL transmission based on the first configuration information; and transmit, via the transceiver, at least one of the S-SSB(s) or the SL transmission on a set of resources within the selected resources in the case that the UE obtains an access opportunity to the RB set.

In some embodiments of the present application, the first configuration information is determined according to at least one of: bandwidth part (BWP), RB set, channel, resource pool, or subcarrier spacing configured for the BWP, RB set, or channel.

In some embodiments of the present application, each interlace within an interlace combination is associated with a transmission type which indicates S-SSB transmission or SL transmission.

In some embodiments of the present application, in the case that an interlace RB-based transmission scheme is applied to S-SSB transmission, to select the resources, the processor is configured to perform at least one of: in the case that the UE intends to transmit the S-SSB(s) on N0 interlace(s), selecting N0 interlace(s) from the set of interlaces applied for the RB set for transmitting the S-SSB(s), wherein N0 is a positive integer; in the case that the UE intends to transmit the S-SSB(s) on N1 interlace(s), selecting an interlace combination from the set of interlace combinations applied for the RB set, wherein N1 is a positive integer, and the selected interlace combination includes at least N1 interlace(s) being available for S-SSB transmission; in the case that the UE intends to transmit the SL transmission on N2 interlace(s), selecting an interlace combination from the set of interlace combinations applied for the RB set, wherein N2 is a positive integer, and the selected interlace combination includes at least N2 interlace(s) being available for SL transmission; or in the case that the UE intends to transmit the S-SSB(s) on N3 interlace(s) and the SL transmission on N4 interlace(s), selecting an interlace combination from the set of interlace combinations applied for the RB set, wherein N3 and N4 are positive integers, and the selected interlace combination includes at least N3 interlaces being available for S-SSB transmission and at least N4 interlaces being available for SL transmission.

In some embodiments of the present application, an interlace of the N0 interlace(s) is randomly selected by the UE, or selected based on an identity (ID) of the UE and the number of available interlaces for transmitting the S-SSB(s), or selected based on a synchronization priority level of the UE; or the interlace combination is randomly selected by the UE, or selected based on the ID of the UE and the number of available interlace combinations for transmitting at least one of the S-SSB(s) or the SL transmission, or selected based on a synchronization priority level of the UE.

In some embodiments of the present application, each interlace combination in the set of interlace combinations is determined such that a maximized power per RB achieved by the interlace combination is higher than a maximized power per RB achieved by any other plurality of interlaces having the same number of interlaces as the interlace combination.

In some embodiments of the present application, the first configuration information further indicates a second plurality of RBs for SL transmission, wherein the second plurality of RBs for SL transmission locate between the S-SSB repetitions, and wherein in the case that a repetition-based transmission scheme is applied to S-SSB transmission, to select the resources, the processor is configured to perform at least one of: in the case that the UE intends to transmit the S-SSB(s), selecting the first plurality of RBs for S-SSB repetitions for transmitting the S-SSB(s); or in the case that the UE intends to transmit the S-SSB(s) and the SL transmission, selecting the first plurality of RBs for S-SSB repetitions for transmitting the S-SSB(s) and selecting a set of RBs within the second plurality of RBs for SL transmission for transmitting the SL transmission.

In some embodiments of the present application, the first configuration information indicates at least one of: a location of the lowest RB for each S-SSB repetition and the number of RBs for each S-SSB repetition; or a location of the lowest RB for SL transmission and the number of RBs for SL transmission.

In some embodiments of the present application, the processor is further configured to: obtain second configuration information indicating at least one of: a first cyclic prefix extension (CPE) value for S-SSB transmission and for simultaneous S-SSB transmission and SL transmission within one slot; or a first channel access priority class (CAPC) value for S-SSB transmission and for simultaneous S-SSB transmission and SL transmission within one slot; and perform a listen-before-talk (LBT) to obtain the access opportunity to the RB set based on the second configuration information.

In some embodiments of the present application, at least one of the first CPE value or the first CAPC value is also used for SL transmission, or the second configuration information further indicates at least one of: a second CPE value for SL transmission, wherein the first CPE value is greater than the second CPE value; or a second CAPC value for SL transmission, wherein the first CAPC value is lower than the second CAPC value.

According to some embodiments of the present application, a UE may include: a transceiver; a processor coupled to the transceiver and configured to: obtain first configuration information for SL, wherein the first configuration information indicates at least one of the following: an interlace pattern; a set of interlaces for S-SSB transmission; a set of interlace combinations for at least one of S-SSB transmission or SL transmission, wherein each interlace combination includes at least two interlaces; or a first plurality of RBs for S-SSB repetitions in a frequency range, wherein the first plurality of RBs for S-SSB repetitions has a frequency spanning exceeding a predefined percentage of the frequency range; and perform at least one of S-SSB detection or SL transmission detection based on the first configuration information.

In some embodiments of the present application, the first configuration information is determined according to at least one of: BWP, RB set, channel, resource pool, or subcarrier spacing configured for the BWP, RB set, or channel.

In some embodiments of the present application, each interlace within an interlace combination is associated with a transmission type which indicates S-SSB transmission or SL transmission.

In some embodiments of the present application, in the case that an interlace RB-based transmission scheme is applied to S-SSB transmission, to perform at least one of S-SSB detection or SL transmission detection, the processor is configured to perform at least one of: in the case that the UE intends to receive S-SSB in a slot, performing S-SSB detection on interlace(s) being available for S-SSB transmission; or in the case that the UE intends to receive SL transmission in a slot, performing SL transmission detection on interlace(s) being available for SL transmission.

In some embodiments of the present application, the first configuration information further indicates a second plurality of RBs for SL transmission, wherein the second plurality of RBs for SL transmission locate between the S-SSB repetitions, and wherein in the case that a repetition-based transmission scheme is applied to S-SSB transmission, to perform at least one of S-SSB detection or SL transmission detection, the processor is configured to perform at least one of: in the case that the UE intends to receive S-SSB in a slot, performing S-SSB detection on the first plurality of RBs for S-SSB repetitions; or in the case that the UE intends to receive SL transmission in a slot, performing SL transmission detection on the second plurality of RBs for SL transmission.

According to some embodiments of the present application, a BS may include: a transceiver; a processor coupled to the transceiver and configured to: transmit, via the transceiver, first configuration information for SL, wherein the first configuration information indicates at least one of the following: an interlace pattern; a set of interlaces for S-SSB transmission; a set of interlace combinations for at least one of S-SSB transmission or SL transmission, wherein each interlace combination includes at least two interlaces; or a first plurality of RBs for S-SSB repetitions in a frequency range, wherein the first plurality of RBs for S-SSB repetitions has a frequency spanning exceeding a predefined percentage of the frequency range.

In some embodiments of the present application, the first configuration information is determined according to at least one of: BWP, RB set, channel, resource pool, or subcarrier spacing configured for the BWP, RB set, or channel.

In some embodiments of the present application, each interlace within an interlace combination is associated with a transmission type which indicates S-SSB transmission or SL transmission.

In some embodiments of the present application, the first configuration information further indicates a second plurality of RBs for SL transmission, wherein the second plurality of RBs for SL transmission locate between the S-SSB repetitions.

In some embodiments of the present application, the first configuration information indicates at least one of: a location of the lowest RB for each S-SSB repetition and the number of RBs for each S-SSB repetition; or a location of the lowest RB for SL transmission and the number of RBs for SL transmission.

In some embodiments of the present application, the processor is further configured to: transmit, via the transceiver, second configuration information indicating at least one of: a first CPE value for S-SSB transmission and for simultaneous S-SSB transmission and SL transmission within one slot; or a first CAPC value for S-SSB transmission and for simultaneous S-SSB transmission and SL transmission within one slot.

In some embodiments of the present application, at least one of the first CPE value or the first CAPC value is also used for SL transmission, or the second configuration information further indicates at least one of: a second CPE value for SL transmission, wherein the first CPE value is greater than the second CPE value; or a second CAPC value for SL transmission, wherein the first CAPC value is lower than the second CAPC value.

In some embodiments of the present application, the processor is configured to transmit, via the transceiver, the first configuration information or the second configuration information via at least one of: a master information block (MIB) message, a system information block (SIB) message, a radio resource control (RRC) signaling, a medium access control (MAC) control element (CE), or downlink control information (DCI).

According to some embodiments of the present application, a method performed by a UE may include: obtaining first configuration information for SL, wherein the first configuration information indicates at least one of the following: an interlace pattern; a set of interlaces for S-SSB transmission; a set of interlace combinations for at least one of S-SSB transmission or SL transmission, wherein each interlace combination includes at least two interlaces; or a first plurality of RBs for S-SSB repetitions in a frequency range, wherein the first plurality of RBs for S-SSB repetitions has a frequency spanning exceeding a predefined percentage of the frequency range; selecting resources within an RB set for transmitting at least one of S-SSB(s) or an SL transmission based on the first configuration information; and transmitting at least one of the S-SSB(s) or the SL transmission on a set of resources within the selected resources in the case that the UE obtains an access opportunity to the RB set

According to some embodiments of the present application, a method performed by a UE may include: obtaining first configuration information for SL, wherein the first configuration information indicates at least one of the following: an interlace pattern; a set of interlaces for S-SSB transmission; a set of interlace combinations for at least one of S-SSB transmission or SL transmission, wherein each interlace combination includes at least two interlaces; or a first plurality of RBs for S-SSB repetitions in a frequency range, wherein the first plurality of RBs for S-SSB repetitions has a frequency spanning exceeding a predefined percentage of the frequency range; and performing at least one of S-SSB detection or SL transmission detection based on the first configuration information.

According to some embodiments of the present application, a method performed by a BS may include: transmitting first configuration information for SL, wherein the first configuration information indicates at least one of the following: an interlace pattern; a set of interlaces for S-SSB transmission; a set of interlace combinations for at least one of S-SSB transmission or SL transmission, wherein each interlace combination includes at least two interlaces; or a first plurality of RBs for S-SSB repetitions in a frequency range, wherein the first plurality of RBs for S-SSB repetitions has a frequency spanning exceeding a predefined percentage of the frequency range.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present application;

FIG. 2 illustrates an exemplary S-SSB slot according to some embodiments of the present application;

FIG. 3 illustrates a flowchart of an exemplary method for S-SSB transmission and SL transmission according to some embodiments of the present application;

FIG. 4 illustrates an exemplary interlace RB-based structure for 15 kHz SCS in 20 MHz bandwidth according to some embodiments of the present application;

FIG. 5 illustrates exemplary frequency-domain multiplexing (FDM) of S-SSB transmission and SL transmission according to some embodiments of the present application;

FIGS. 6A and 6B illustrates two exemplary combinations of interlaces according to some embodiments of the present application;

FIG. 7 illustrates exemplary FDM of S-SSB transmission and SL transmission according to some other embodiments of the present application;

FIG. 8 illustrates a flowchart of an exemplary method for S-SSB transmission and SL transmission according to some other embodiments of the present application; and

FIG. 9 illustrates a simplified block diagram of an exemplary apparatus for S-SSB transmission and SL transmission in an unlicensed spectrum according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present application, examples of which are illustrated in the accompanying drawings. To facilitate understanding, embodiments are provided under specific network architecture and new service scenarios, such as 3GPP LTE and LTE advanced, 3GPP 5G new radio (NR), 5G-Advanced, 6G, and so on. It is contemplated that along with developments of network architectures and new service scenarios, all embodiments in the present application are also applicable to similar technical problems; and moreover, the terminologies recited in the present application may change, which should not affect the principle of the present application.

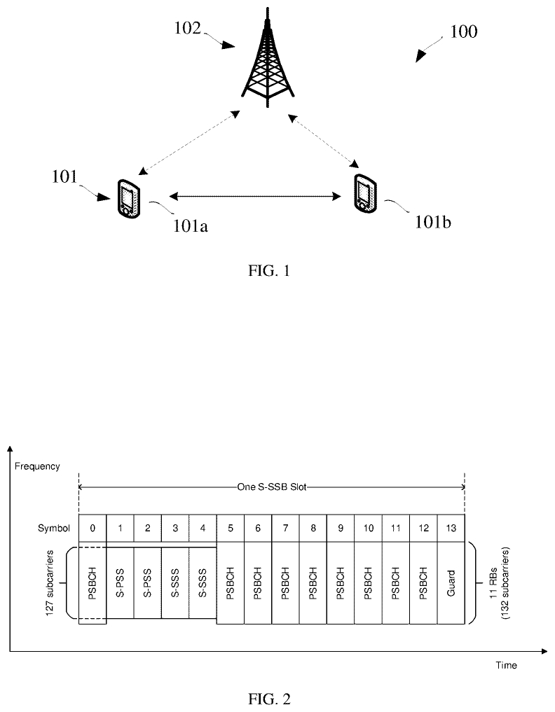

FIG. 1 illustrates an exemplary wireless communication system 100 in accordance with some embodiments of the present application.

As shown in FIG. 1, the wireless communication system 100 includes at least one UE 101 and at least one BS 102. In particular, the wireless communication system 100 includes two UEs 101 (e.g., UE 101a and UE 101b) and one BS 102 for illustrative purpose. Although a specific number of UEs 101 and BS 102 are depicted in FIG. 1, it is contemplated that any number of UEs 101 and BSs 102 may be included in the wireless communication system 100.

According to some embodiments of the present disclosure, the UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to some other embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the present disclosure, the UE(s) 101 may include wearable devices, such as smart watches, fitness bands, optical head-mounted displays, or the like.

According to some embodiments of the present disclosure, the UE(s) 101 may include vehicle UEs (VUEs) and/or power-saving UEs (also referred to as power sensitive UEs). The power-saving UEs may include vulnerable road users (VRUs), public safety UEs (PS-UEs), and/or commercial sidelink UEs (CS-UEs) that are sensitive to power consumption. In an embodiment of the present disclosure, a VRU may include a pedestrian UE (P-UE), a cyclist UE, a wheelchair UE or other UEs which require power saving compared with a VUE.

Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

In a sidelink communication system, a transmission UE may also be named as a transmitting UE, a Tx UE, a sidelink Tx UE, a sidelink transmission UE, or the like. A reception UE may also be named as a receiving UE, an Rx UE, a sidelink Rx UE, a sidelink reception UE, or the like.

According to some embodiments of FIG. 1, UE 101a functions as a Tx UE, and UE 101b functions as an Rx UE. UE 101a may exchange sidelink messages with UE 101b through a sidelink, for example, via PC5 interface as defined in 3GPP TS 23.303. UE 101a may transmit information or data to other UE(s) within the sidelink communication system, through sidelink unicast, sidelink groupcast, or sidelink broadcast. For instance, UE 101a may transmit data to UE 101b in a sidelink unicast session. UE 101a may transmit data to UE 101b and other UE(s) in a groupcast group (not shown in FIG. 1) by a sidelink groupcast transmission session. Also, UE 101a may transmit data to UE 101b and other UE(s) (not shown in FIG. 1) by a sidelink broadcast transmission session.

Alternatively, according to some other embodiments of FIG. 1, UE 101b functions as a Tx UE and transmits sidelink messages, and UE 101a functions as an Rx UE and receives the sidelink messages from UE 101b.

In some embodiments of the present disclosure, UE 101a may communicate with UE 101b over licensed spectrums, whereas in other embodiments, UE 101a may communicate with UE 101b over unlicensed spectrums.

Both UE 101a and UE 101b in the embodiments of FIG. 1 may transmit information to BS 102 and receive control information from BS 102, for example, via LTE or NR Uu interface. BS 102 may be distributed over a geographic region. In certain embodiments of the present disclosure, BS 102 may also be referred to as an access point, an access terminal, a base, a base unit, a macro cell, a Node-B, an evolved Node B (eNB), a generalized Node B (gNB), a Home Node-B, a relay node, or a device, or described using other terminology used in the art. BS 102 is generally a part of a radio access network that may include one or more controllers communicably coupled to BS 102.

The wireless communication system 100 may be compatible with any type of network that is capable of sending and receiving wireless communication signals. For example, the wireless communication system 100 is compatible with a wireless communication network, a cellular telephone network, a time division multiple access (TDMA) based network, a code division multiple access (CDMA) based network, an orthogonal frequency division multiple access (OFDMA) based network, an LTE network, a 3GPP-based network, a 3GPP 5G network, a satellite communications network, a high-altitude platform network, and/or other communications networks.

In some embodiments of the present disclosure, the wireless communication system 100 is compatible with the 5G NR of the 3GPP protocol, wherein BS(s) 102 transmit data using an orthogonal frequency division multiplexing (OFDM) modulation scheme on the downlink (DL) and UE(s) 101 transmit data on the uplink (UL) using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, BS(s) 102 may communicate using other communication protocols, such as the IEEE 802.11 family of wireless communication protocols. Further, in some embodiments of the present disclosure, BS(s) 102 may communicate over licensed spectrums, whereas in other embodiments, BS(s) 102 may communicate over unlicensed spectrums. The present disclosure is not intended to be limited to the implementation of any particular wireless communication system architecture or protocol. In yet some embodiments of the present disclosure, BS(s) 102 may communicate with UE(s) 101 using the 3GPP 5G protocols.

In NR, accommodating multiple uncoordinated UEs in an unlicensed spectrum requires channel access procedures defined for NR. Following a successful channel access procedure performed by a communicating node, the channel can be used by the communicating node during a period until the end of the period. Such a period may be referred to as a channel occupancy time (COT). During a COT, one or more transmissions may be exchanged between the communicating nodes, wherein a transmission may be a downlink transmission or an uplink transmission.

Dynamic channel access procedures are usually used by a BS or a UE to access a channel in an unlicensed spectrum. Dynamic channel access procedures may be based on LBT, where a transmitter listens to potential transmission activity on a channel prior to transmitting and applies a random back-off time in some cases. Two main types of dynamic channel access procedures may be defined in NR. One is Type-1 dynamic channel access procedure, which is also referred to as LBT type 1 or LBT cat4. The other is Type-2 dynamic channel access procedure, which is also referred to as LBT type 2.

Type-1 dynamic channel access procedure may be used to initiate data transmission at the beginning of a COT. The initiator for the Type-1 dynamic channel access procedure may be either a BS or a UE. The Type-1 dynamic channel access procedure may be summarized as follows.

First, the initiator listens and waits until a channel (e.g., a frequency channel) is available during at least one period referred to as a defer duration. The defer duration may consist of 16 μs and a number (e.g., “mₚ” in the following Table 1 or Table 2, which will be illustrated below) of 9 μs slots. As shown in Table 1 and Table 2, a value of “mₚ” depends on a value of CAPC (represented as “p”). Accordingly, the defer duration depends on the value of CAPC as shown in the following Table 1 or Table 2. A channel is declared to be available if the received energy during at least 4 μs of each 9 μs slot is below a threshold.

Once the channel has been declared available during the defer duration, the transmitter starts a random back-off procedure during which it will wait a random period of time.

The UE starts the random back-off procedure by initializing a back-off timer with a random number within a contention window (CW). The random number is drawn from a uniform distribution [0, CW] and represents that the channel must be available for a timer duration (e.g., defined by the random number multiplying 9 μs) before transmission can take place. The value of “CW” may be selected from “allowed CWₚ sizes” (the minimum value is represented as CW_{min,p}, and the maximum value is represented as CW_{max,p}) in the following Table 1 or Table 2, which depends on a value of CAPC.

The back-off timer is decreased by one for each sensing slot duration (e.g., 9 μs) the channel is sensed to be idle; whenever the channel is sensed to be busy, the back-off timer is put on hold until the channel has been idle for a defer duration.

Once the back-off timer has expired (e.g., the back-off timer is decreased to be 0), the random back-off procedure is completed, and the transmitter has acquired the channel and can use it for transmission up to MCOT (e.g., T_{mcot,p} in the following Table 1 or T_{ulmcot,p} in the following Table 2, which depends on a value of CAPC).

The following Table 1 and Table 2 illustrate exemplary CAPC for DL and CAPC for UL, respectively, and corresponding values of mₚ, CW_{min,p}, CW_{max,p}, T_{mcot,p}, T_{ulmcot,p}, and allowed P sizes. Table 1 is the same as Table 4.1.1-1 in TS 37.213 and Table 2 is the same as Table 4.2.1-1 in TS 37.213. When a BS intends to initiate a channel occupancy for DL transmission, it may determine a CAPC value before performing a Type-1 channel access procedure, and then determine the corresponding values (e.g., mₚ, CW_{min,p}, CW_{max,p}, T_{mcot,p}, and allowed CWₚ sizes) used in the Type-1 channel access procedure according to Table 1. When a UE intends to initiate a channel occupancy for UL transmission, it may determine a CAPC value before performing a Type-1 channel access procedure, and then determine the corresponding values (e.g., mₚ, CW_{min,p}, CW_{max,p}, T_{ulmcot,p}, and allowed CWₚ sizes) used in the Type-1 channel access procedure according to Table

TABLE 1
Channel Access Priority Class for DL

| Channel | | | | | |
|---|---|---|---|---|---|
| Access | | | | | |
| Priority | | | | | |
| Class (p) | mₚ | CW_{min, p} | CW_{max, p} | T_{mcot, p} | allowed CWₚsizes |
| 1 | 1 | 3 | 7 | 2 ms | {3, 7} |
| 2 | 1 | 7 | 15 | 3 ms | {7, 15} |
| 3 | 3 | 15 | 63 | 8 or | {15, 31, 63} |
| | | | | 10 ms | |
| 4 | 7 | 15 | 1023 | 8 or | {15, 31, 63, 127, 255, |
| | | | | 10 ms | 511, 1023} |

TABLE 2
Channel Access Priority Class for UL

| Channel | | | | | |
|---|---|---|---|---|---|
| Access | | | | | |
| Priority | | | | | |
| Class (p) | mₚ | CW_{min, p} | CW_{max, p} | T_{mcot, p} | allowed CWₚsizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or | {15, 31, 63, 127, |
| | | | | 10 ms | 255, 511, 1023} |
| 4 | 7 | 15 | 1023 | 6 ms or | {15, 31, 63, 127, 255, |
| | | | | 10 ms | 511, 1023} |

NOTE1:
For p = 3, 4, T_{ulmcot, p} = 10 ms if the higher layer parameter ‘absenceOfAnyOtherTechnology-r14’ indicates TRUE, otherwise, T_{ulmcot, p} = 6 ms.
NOTE 2:
When T_{ulmcot, p} = 6 ms it may be increased to 8 ms by inserting one or more gaps. The minimum duration of a gap shall be 100 μs. The maximum duration before including any such gap shall be 6 ms.

The size of the contention window may be adjusted based on hybrid automatic repeat request (HARQ) reports received from the transmitter during a reference interval, which covers the beginning of the COT. For each received HARQ report, the contention window is (approximately) doubled up to the limit CW_{max,p} if a negative HARQ report (e.g., non-acknowledgement (NACK)) is received. For a positive HARQ report (e.g., acknowledgement (ACK)), the contention window is reset to its minimum value, i.e., CW=CW_{min,p}.

Type-2 dynamic channel access procedure may be used for COT sharing and transmission of discovery bursts. Depending on a duration of a gap (also referred to as “COT sharing gap”) in the COT, Type-2 dynamic channel access procedure may be further classified into the following three procedures, wherein which procedure to be used may be determined depending on the duration of the gap between two transmission bursts.
Type 2A dynamic channel access procedure (also referred to as LBT cat2 or LBT type 2A): which is used when the gap is 25 μs or more for transmission of the discovery bursts.
Type 2B dynamic channel access procedure (also referred to as LBT type 2B): which is used when the gap is 16 μs.
Type 2C dynamic channel access procedure (also referred to as LBT type 2C): which is used when the gap is 16 μs or less after the preceding transmission burst.

For Type 2C dynamic channel access procedure, no idle sensing is required between the transmission bursts. In such scenario, the duration of a transmission burst is limited to at most 584 μs. Such a short transmission burst may carry small amount of user data, uplink control information (UCI) such as HARQ status reports and channel state information (CSI) reports.

Type 2A dynamic channel access procedure and Type 2B dynamic channel access procedure may be similar to Type-1 dynamic channel access procedure but without the random back-off. That is, in Type 2A dynamic channel access procedure and Type 2B dynamic channel access procedure, if a channel is detected to be idle in the gap, it is declared to be available; if it is detected to be busy, the COT sharing has failed and the transmission cannot occur using COT sharing in this COT. If the COT sharing gap is 16 μs, Type 2B dynamic channel access procedure may be used and the channel must be detected to be idle in the 16 μs gap prior to the next transmission burst. If the COT sharing gap is 25 μs or longer, Type 2A dynamic channel access procedure may be used and the channel must be detected to be idle during at least 25 μs immediately preceding the next transmission burst.

The above embodiments provide several dynamic channel access procedures in an unlicensed spectrum for NR. These dynamic channel access procedures may also apply for sidelink transmissions in an unlicensed spectrum.

Sidelink synchronization information is carried in an S-SSB that consists of physical sidelink broadcast channel (PSBCH), sidelink primary synchronization signal (S-PSS) and sidelink secondary synchronization signal (S-SSS). FIG. 2 illustrates an exemplary S-SSB slot according to some embodiments of the present disclosure. In the embodiments of FIG. 2, a normal cyclic prefix (CP) is used.

Referring to FIG. 2, an S-SSB occupies one slot in the time domain and occupies 11 RBs in the frequency domain. Each RB spans 12 subcarriers, thus the S-SSB bandwidth is 132 (11×12) subcarriers. In the example of FIG. 2, the S-SSB slot may include 14 OFDM symbols in total, e.g., symbol #0 to symbol #13. The S-PSS is transmitted repeatedly on the second and third symbols in the S-SSB slot, e.g., symbol #1 and symbol #2. The S-SSS is transmitted repeatedly on the fourth and fifth symbols in the S-SSB slot, e.g., symbol #3 and symbol #4. The S-PSS and the S-SSS occupy 127 subcarriers in the frequency domain, which are from the third subcarrier relative to the start of the S-SSB bandwidth up to the 129th subcarrier.

The S-PSS and the S-SSS are jointly referred to as the sidelink synchronization signal (SLSS). The SLSS is used for time and frequency synchronization. By detecting the SLSS sent by a synchronization reference UE (also referred to as a SyncRef UE), a UE is able to synchronize to the SyncRef UE and estimate the beginning of the frame and carrier frequency offsets.

The S-PSS may be generated from the maximum length sequences (m-sequences) that use the same design (i.e., generator polynomials, initial values and cyclic shifts, etc.) which is used for generating the m-sequences in the primary synchronization signal (PSS) in the 3GPP documents. In NR Uu, there are three candidate sequences for PSS. However, only two candidate sequences are used for S-PSS.

The S-SSS may be generated from the Gold sequences that use the same design (i.e., generator polynomials, initial values and cyclic shifts, etc.) which is utilized for generating the Gold sequences for the secondary synchronization signal (SSS) in the 3GPP documents. This results in 336 candidate sequences for S-SSS like for the SSS in NR Uu.

For the transmission of SLSS within an S-SSB, a SyncRef UE may select an S-PSS and an S-SSS out of the candidate sequences based on an SLSS identifier (ID). The SLSS ID represents an identifier of the SyncRef UE and conveys a priority of the SyncRef UE as in LTE vehicle-to-everything (V2X). Each SLSS ID corresponds to a unique combination of an S-PSS and an S-SSS out of the 2 S-PSS candidate sequences and the 336 S-SSS candidate sequences.

The main purpose of the PSBCH is to provide system-wide information and synchronization information that is required by a UE for establishing a sidelink connection. In the example of FIG. 2, the PSBCH is transmitted on the first symbol (e.g., symbol #0) and the eight symbols (e.g., symbol #5 to symbol #12) after the S-SSS in the S-SSB slot. In the case that an extended CP is used, the PSBCH is transmitted on the first symbol and the six symbols after the S-SSS in the S-SSB slot. The PSBCH occupies 132 subcarriers in the frequency domain. The PSBCH in the first symbol of the S-SSB slot is used for automatic gain control (AGC). The last symbol, e.g., symbol #13, in the S-SSB slot is used as a guard symbol.

In some embodiments of the present application, S-SSB may be transmitted on an unlicensed spectrum. For S-SSB transmission over an unlicensed spectrum, some requirements should be met. These requirements may include at least one of the followings:
Occupied channel bandwidth (OCB) requirement, which requires that the bandwidth containing 99% of the power of the signal, shall be between 80% and 100% of declared Nominal Channel Bandwidth; or
Power Spectral Density (PSD) requirement, which constraints power to 10 dBm per MHz bandwidth at most.

According to some embodiments of the present application, an interlace RB-based transmission scheme or a repetition-based transmission scheme may be applied to S-SSB transmission for meeting at least one of the OCB requirement or the PSD requirement. In 3GPP Release 16 or Release 17, S-SSB spans 11 RBs in the frequency domain within the SL BWP. However, a channel bandwidth in an unlicensed spectrum may be 20 MHz or even wider. In such cases, once OCB requirement is satisfied by S-SSB, how to utilize the remaining resources in the frequency domain within a wide channel is an issue needed to be solved.

Given the above, embodiments of the present application provide solutions for SL transmission (e.g., at least one of physical sidelink control channel (PSCCH) transmission or physical sidelink shared channel (PSSCH) transmission) and S-SSB transmission in unlicensed spectra. For example, embodiments of the present application provide frequency-domain structures and UE behaviours in S-SSB transmission and/or SL transmission, which can support FDM of S-SSB transmission and SL transmission, thereby enhancing the spectrum efficiency. More details will be described in the following text in combination with the appended drawings.

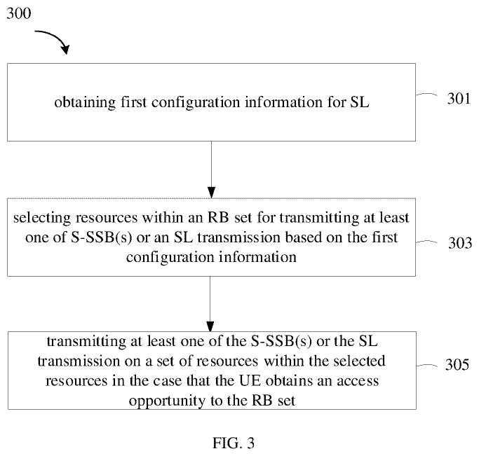

FIG. 3 illustrates a flowchart of an exemplary method 300 for S-SSB transmission and SL transmission according to some embodiments of the present application. The method 300 illustrated in FIG. 3 may be performed by a UE (e.g., UE 101a or UE 101b in FIG. 1) which intends to transmit at least one of S-SSB(s) or an SL transmission or other apparatus with the like functions.

As shown in FIG. 3, in step 301, the UE may obtain first configuration information for SL. For example, the UE may obtain the first configuration information based on configuration, pre-configuration, or pre-definition.

In some embodiments of the present application, the UE may obtain the first configuration information based on configuration. Specifically, obtaining the first configuration information based on configuration (i.e., the first configuration information is configured to the UE) may refer to that: the first configuration information is transmitted by a BS (e.g., BS 102 as shown in FIG. 1) to the UE via at least one of: a SIB message, a MIB message, an RRC signaling, or a MAC CE, or DCI, such that the UE may receive the first configuration information from the BS. In an embodiment of the present application, obtaining the first configuration information based on configuration may apply to the scenario where the UE is in coverage of a network.

In some other embodiments of the present application, the UE may obtain the first configuration information based on pre-configuration or pre-definition. Specifically, obtaining the first configuration information based on pre-configuration or pre-definition (i.e., the first configuration information is pre-configured or pre-defined to the UE) may refer to that: the first configuration information may be hard-wired into the UE or stored on a subscriber identity module (SIM) or universal subscriber identity module (USIM) card for the UE, such that the UE may obtain the first configuration information within the UE. In an embodiment of the present application, obtaining the first configuration information based on pre-configuration or pre-definition may apply to the scenario where the UE is out of coverage of the network.

In some embodiments of the present application, the first configuration information may be determined according to at least one of: BWP, RB set, channel, resource pool, or subcarrier spacing configured for the BWP, RB set, or channel.

In some embodiments of the present application, the first configuration information may be based on at least one of the following granularities: per BWP, per RB set, per channel, per resource pool, or per subcarrier spacing configured for the BWP, RB set, or channel.

In some embodiments of the present application, the first configuration information may include at least one of:
an interlace pattern;
a set of interlaces for S-SSB transmission;
a set of interlace combinations for at least one of S-SSB transmission or SL transmission, wherein each interlace combination includes at least two interlaces; or
a first plurality of RBs for S-SSB repetitions in a frequency range, wherein the first plurality of RBs for S-SSB repetitions has a frequency spanning exceeding a predefined percentage of the frequency range.

The definition regarding each of the above items included in the first configuration information will be described in detail later.

In step 303, the UE may select resources within an RB set for transmitting at least one of S-SSB(s) or an SL transmission (e.g., at least one of PSCCH transmission or PSSCH transmission) based on the first configuration information. The specific operations performed in step 303 will be described in detail later.

In step 305, the UE may transmit at least one of the S-SSB(s) or the SL transmission on a set of resources within the selected resources in the case that the UE obtains an access opportunity to the RB set. The specific operations performed in step 305 will be described in detail later.

According to some embodiments of the present application, an interlace RB-based transmission scheme may be applied to S-SSB transmission.

To support the interlace RB-based transmission scheme, a channel (e.g., an RB set) may be divided into a number of interlaces. The number of interlaces included in the channel may depend on the SCS for the channel. For example, for 15 kHz SCS, there may be 10 interlaces for the channel; and for 30 kHz SCS, there may be 5 interlaces.

For a channel which is divided into N interlaces, every Nth RB belongs to the same interlace. The number of RBs of each interlace may be dependent on the bandwidth of the channel. For example, for a channel of 20 MHz bandwidth with 15 kHz SCS, each of the 10 interlaces may include 10 or 11 RBs; and for a channel of 20 MHz bandwidth with 30 kHz SCS, each of the 5 interlaces may include 10 or 11 RBs.

The following Table 3 shows the number of RBs (e.g., N_{RB}) included in different bandwidths for different SCSs for frequency range 1 (FR1) (e.g., 450 MHz-7125 MHz).

TABLE 3
Max transmission bandwidth configuration N_{RB} for FR1 (450-7125 MHz)

| | 5 | 10 | 15 | 20 | 25 | 30 | 40 | 50 | 60 | 80 | 100 |
|---|---|---|---|---|---|---|---|---|---|---|---|
| SCS | MHz | MHz | MHz | MHz | MHz | MHz | MHz | MHz | MHz | MHz | MHz |
| (kHz) | N_{RB} | N_{RB} | N_{RB} | N_{RB} | N_{RB} | N_{RB} | N_{RB} | N_{RB} | N_{RB} | N_{RB} | N_{RB} |
| 15 | 25 | 52 | 79 | 106 | 133 | [160] | 216 | 270 | N/A | N/A | N/A |
| 30 | 11 | 24 | 38 | 51 | 65 | [78] | 106 | 133 | 162 | 217 | 273 |
| 60 | N/A | 11 | 18 | 24 | 31 | [38] | 51 | 65 | 79 | 107 | 135 |

Referring to Table 3, taking 20 MHz bandwidth as an example, for 15 kHz SCS, the 20 MHz bandwidth includes 106 RBs; for 30 kHz SCS, the 20 MHz bandwidth includes 51 RBs.

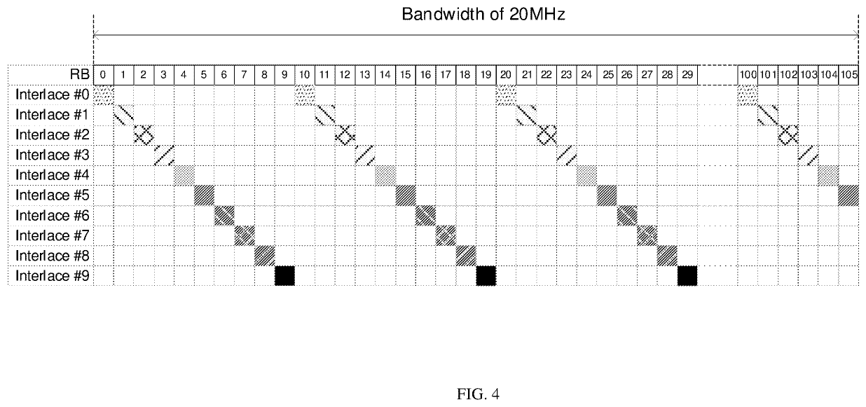

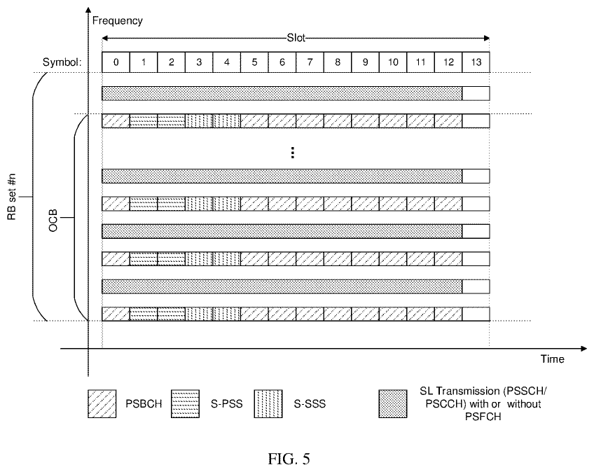

FIG. 4 illustrates an exemplary interlace RB-based structure (also referred to as interlace pattern) for 15 kHz SCS in 20 MHz bandwidth according to some embodiments of the present application. It should be understood that the interlace RB-based structure in FIG. 4 is only for illustrative purposes and should not be construed as limiting the embodiments of the present disclosure.

As shown in FIG. 4, the channel (e.g., RB set) with 20 MHz bandwidth may include 106 RBs (e.g., denoted as RBs 0-105), and the RBs of the channel are divided into 10 interlaces (denoted as interlaces #0-#9). Within interlaces #0 to #5, each interlace contains 11 RBs. Within interlaces #6 to #9, each interlace contains 10 RBs.

Each interlace of the 10 interlaces may include evenly-spaced RBs in the frequency domain. As shown in FIG. 4, interlace #0 may include RB 0, RB 10, RB 20, RB 30, and so on; interlace #1 may include RB 1, RB 11, RB 21, RB 31, and so on; . . . ; and interlace #9 may include RB 9, RB 19, RB 29, and so on.

The concept of “RB set” is specified in Release 16 5G NR in unlicensed spectrum (NR-U), which defines the exact available RBs without RBs in either inter-cell guard band or intra-cell guard band. The guard band and RB set are configured by RRC signaling in unit of common resource block (CRB). In detail, when the UE is configured with intraCellGuardBand for a carrier, the UE is provided with N_{RB-set}−1 intra-cell guard bands on the carrier, each defined by a start CRB and an end CRB, i.e.,

$${GB}_{s}^{start , μ} and {GB}_{s}^{end , μ} ,$$

respectively. The intra-cell guard bands separate N_{RB-set} RB sets, each defined by a start CRB and an end CRB, i.e.,

$${RB}_{s}^{start , μ} and {RB}_{s}^{end , μ} ,$$

respectively. The UE determines

$$\begin{matrix}{RB}_{0}^{scart , μ} = {N}_{grid}^{start , μ} , \\ {RB}_{{N}_{RB - set} - 1}^{end , μ} = {N}_{grid}^{start , μ} + {N}_{grid}^{s ize , μ} ,\end{matrix}$$

and the remaining end and start CRBs as

$$\begin{matrix}{RB}_{s}^{end , μ} = \\ {GB}_{s}^{start , μ} - 1 and {RB}_{s + 1}^{start , μ} = {GB}_{s}^{end , μ} + 1.\end{matrix}$$

When the UE is not configured with intraCellGuardBand, the UE determines intra-cell guard band and corresponding RB set according to the default intra-cell guard band pattern from TS38.101 corresponding to μ and carrier size

$${N}_{grid}^{size , μ} .$$

The specific definitions of the variables or parameters as mentioned above can be found in 3GPP standard documents.

FIG. 5 illustrates exemplary FDM of S-SSB transmission and SL transmission according to some embodiments of the present application. In the example of FIG. 5, the interlace RB-based transmission scheme is applied to S-SSB transmission.

Referring to FIG. 5, in the frequency domain, for RB set #n, the S-SSB transmission may meet the OCB requirement due to the interlace RB-based structure, and the remaining resources within RB set #n may be used for SL transmissions with or without physical sidelink feedback channel (PSFCH). That is, either S-SSB transmission or SL transmission may map to one or more interlaces within RB set #n, wherein the interlaces included in RB set #n may be determined based on the interlace pattern configured for RB set #n. In the time domain, the S-SSB and SL transmission may follow any slot structures as specified in 3GPP (e.g., Release 15, Release 16, Release 17, Release 18 and so on) for S-SSB and SL transmission, respectively. For example, the slot structure for S-SSB in FIG. 5 may be the same as that illustrated in FIG. 2.

To support the FDM between the S-SSB transmission and SL transmission when the interlace RB-based transmission scheme is applied to S-SSB transmission, the first configuration information obtained by the UE in step 301 may include at least one of:
An interlace pattern, which may indicate the information of interlaces. For example, the information of interlaces may include at least one of: the number of interlaces, indexes of the interlaces, and RBs belonging to or included in each interlace. For example, the interlace pattern may indicate the interlace pattern as shown in FIG. 4.
A set of interlaces for S-SSB transmission. The set of interlaces may be available for S-SSB transmission and may include one or more interlaces.
A set of interlace combinations for at least one of S-SSB transmission or SL transmission. The set of interlace combinations may include one or more interlace combinations. Each interlace combination may include at least two interlaces.
Each interlace in a interlace combination may be available for S-SSB transmission, for SL transmission, or for both S-SSB transmission and SL transmission. Such availability may be implicitly or explicitly indicated to the UE. For example, each interlace within an interlace combination is associated with a transmission type which indicates S-SSB transmission or SL transmission. In the case that the transmission type indicates S-SSB transmission, the interlace may be available for S-SSB transmission. In the case that the transmission type indicates SL transmission, the interlace may be available for SL transmission.

In some embodiments, the set of interlace combinations may be determined according to at least one of:
BWP, RB set, channel, or resource pool;
SCS configured for the BWP, RB set, or channel; or
interlace pattern configured to the BWP, RB set, or channel.

In some embodiments, the set of interlace combinations may be determined following some principles. For example, each interlace combination in the set of interlace combinations is determined such that a maximized power per RB achieved by the interlace combination is higher than a maximized power per RB achieved by any other plurality of interlaces having the same number of interlaces as the interlace combination. For example, assuming that an interlace combination in the set of interlace combinations includes N (N≥2) interlaces, then the maximized power per RB achieved by the interlace combination is higher than the maximized power per RB achieved by any other N interlaces.

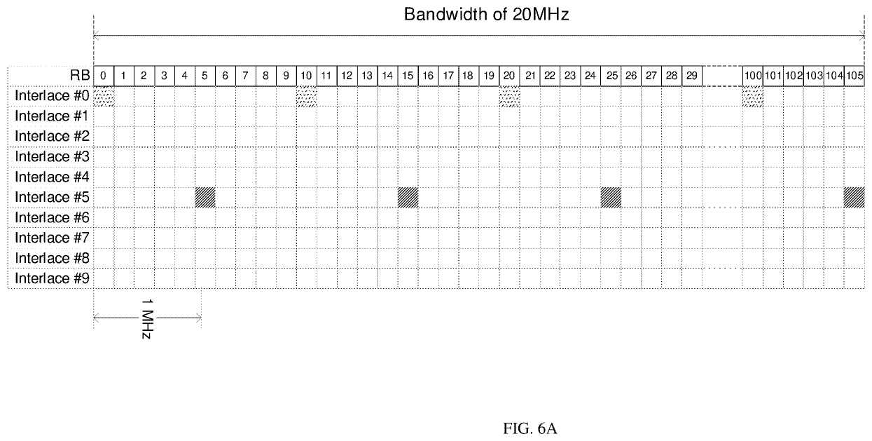

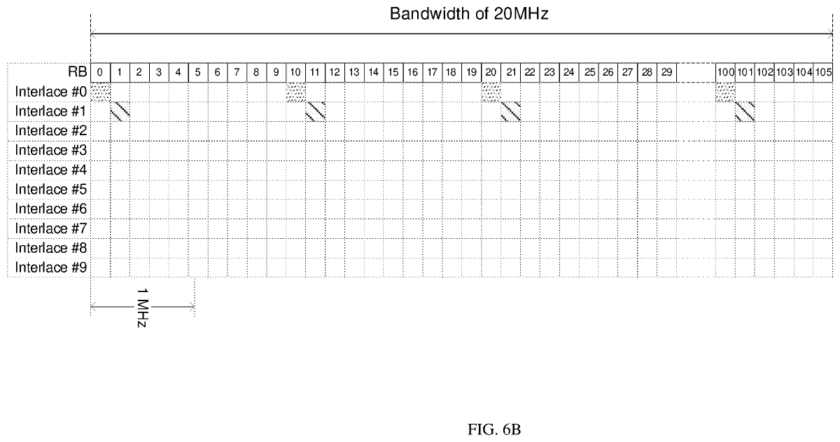

FIGS. 6A and 6B illustrates two exemplary combinations of interlaces according to some embodiments of the present application.

In the examples of FIGS. 6A and 6B, an RB set may be configured with 15 kHz SCS and 20 MHz bandwidth. Similar to FIG. 4, the RB set in FIGS. 6A and 6B may include 106 RB (e.g., denoted as RBs 0-105) and 10 interlaces (e.g., denoted as interlaces #0-#9) in total. Each MHz bandwidth spans about 5.3 RBs.

FIG. 6A illustrates a combination of interlaces #c1 which includes {interlace #0, interlace #5}. Then each MHz bandwidth in the RB set may contain 1.3 RBs within the combination #c1 at most.

FIG. 6B illustrates a combination of interlaces #c2 which includes {interlace #0, interlace #1}. Then each MHz bandwidth in the RB set may contain 2 RBs within the combination #c2 at most. Compared to the combination #c1, the maximized power per RB achieved by the combination #c2 will be much lower. Accordingly, the combination #c1 may be an interlace combination included in the set of interlace combinations while the combination #c2 not.

Based on the examples in FIG. 6A and FIG. 6B, it can be determined that: for the case of 15 kHz SCS, if an interlace combination includes two interlaces #i1 and #i2 where both #i1 and #i2 are within an interlace pattern, then i1 and i2 which meet the condition |i1−i2|=5 may achieve the maximized power per RB. That is, the set of interlace combinations may include all the interlace combinations which include two interlaces #i1 and #i2, wherein |i1−i21=5.

Exemplary interlace combinations may be found in Table 4 shown below. Referring to Table 4, the exemplary interlace combinations for 15 kHz SCS may include interlace combinations {#0, #5}, {#1, #6}, {#2, #7}, {#3, #8}, and {#4, #9}.

As another example, for an RB set configured with 30 kHz SCS and 20 MHz bandwidth, according to Table 3, the RB set may include 51 RBs and 5 interlaces (e.g., denoted as interlaces #0-#44) in total. Each MHz bandwidth spans about 2.55 RBs.

For a combination of interlaces #c3 which includes (interlace #0, interlace #2), each MHz bandwidth in the RB set may contain 1.55 RBs within the combination #c3 at most. For a combination of interlaces #c4 which includes {interlace #0, interlace #1}, each MHz bandwidth in the RB set may contain 2 RBs within the combination #c4 at most. Compared to the combination #c3, the maximized power per RB achieved by the combination #c4 will be much lower. Accordingly, the combination #c3 may be an interlace combination included in the set of interlace combinations while the combination #c4 not.

Based on the above, it can be determined that: for the case of 30 kHz SCS, if an interlace combination includes two interlaces #i3 and #i4 where both #i3 and #i4 are within an interlace pattern, then i3 and i4 which meet the condition |i3−i4|=2 or 3 may achieve the maximized power per RB. That is, the set of interlace combinations may include all the interlace combinations which include two interlaces #i3 and #i4, wherein |i3−i4|=2 or 3.

Referring to Table 4 below, the exemplary interlace combinations for 30 kHz SCS may include interlace combinations {#0, #2}, {#0, #3}, {#1, #3}, {#1, #4}.

TABLE 4
Exemplary Interlace Combinations for 15 kHz SCS and 30 kHz SCS

| | Number of | | Number of | |
|---|---|---|---|---|
| Subcarrier | Interlaces in the | | Interlaces | |
| Spacing | Interlace | Interlace | within a | Interlace |
| (SCS) | Pattern | Pattern | Combination | Combinations |
| 15 kHz | 10 | From | 2 | {#0, #5}, {#1, #6}, |
| | | interlace #0 | | {#2, #7}, {#3, #8}, |
| | | to interlace | | {#4, #9} |
| | | #9 | | |
| 30 kHz | 5 | From | 2 | {#0, #2}, {#0, #3}, |
| | | interlace #0 | | {#1, #3}, {#1, #4} |
| | | to interlace | | |
| | | #4 | | |

As described above, based on the obtained first configuration information, in step 303, the UE may select resources within an RB set for transmitting at least one of S-SSB(s) or an SL transmission. Then, in step 305, the UE may transmit at least one of the S-SSB(s) or the SL transmission on a set of resources within the selected resources in the case that the UE obtains an access opportunity to the RB set. The procedures in steps 303 and 305 may be classified into the following cases according to transmission types permitted in a slot.

### Case 1

In case 1, in a slot where FDM of S-SSB transmission and SL transmission is supported, the SL transmission is only permitted to a UE which performs S-SSB transmission within the same slot. That is, in case 1, the UE may only transmit S-SSB in the slot, or transmit both S-SSB and SL transmission in the slot. Case 1 may further include case 1-1, case 1-2, and case 1-3.

### Case 1-1

In case 1-1, the UE may intend to transmit S-SSB(s) on N0 interlace(s) within an RB set, wherein N0 is a positive integer. For example, N0 may be determined based on the transmission requirement of the S-SSB. Then, in step 303, the UE may select N0 interlace(s) from the set of interlaces (indicated by the first configuration information) applied for the RB set for transmitting the S-SSB(s).

In an embodiment, an interlace of the N0 interlace(s) may be randomly selected by the UE.

In an embodiment, an interlace of the N0 interlace(s) may be selected based on an ID of the UE and the number of available interlaces for transmitting the S-SSB(s). For example, an index of the selected interlace=UE ID mod the total number of available interlaces for transmitting the S-SSB(s).

In an embodiment, an interlace of the N0 interlace(s) may be selected based on a synchronization priority level of the UE.

For example, there are four basic synchronization references from which a UE may derive its own synchronization, i.e., global navigation satellite system (GNSS), its serving BS (e.g., eNB or gNB), another UE transmitting SLSS (e.g., which is referred to as a SyncRef UE), or its own internal clock. In general, GNSS or BS is regarded as the highest-quality sources. SyncRef UEs are distinguished between those which are directly synchronized to GNSS or BS, those which are 1 further step away, and those which are two or more further steps away from GNSS or BS. As a last resort, a UE unable to find any other synchronization reference will use its own internal clock to transmit SLSS. The preference order for synchronization references is as follows, with details specified in TS 36.331, wherein “Level 1” through “Level 5” are priorities for synchronization references from the highest to the lowest.
Level 1: the synchronization reference is either GNSS or BS, according to configuration or pre-configuration.
Level 2: the synchronization reference is a SyncRef UE directly synchronized to a Level 1 source.
Level 3: the synchronization reference is a SyncRef UE synchronized to a Level 2 source, i.e., indirectly synchronized to a Level 1 source.
Level 4: the synchronization reference is any other SyncRef UE.
Level 5: UE's internal clock.

In such example, the UE may obtain another configuration information indicating that each synchronization priority level is mapped to a corresponding interlace. The configuration information may be obtained based on configuration, pre-configuration, or pre-definition. The definitions regarding configuration, pre-configuration, or pre-definition as provided above may also apply here. Accordingly, based on the configuration information, the UE may determine an interlace corresponding to the synchronization priority level of the UE.

### Case 1-2

In case 1-2, the UE may intend to transmit S-SSB(s) on N1 interlace(s) within an RB set, wherein N1 is a positive integer. For example, N1 may be determined based on the transmission requirement of the S-SSB. Then, in step 303, the UE may select an interlace combination from the set of interlace combinations (indicated by the first configuration information) applied for the RB set. The selected interlace combination includes at least N1 interlace(s) being available for S-SSB transmission.

In an embodiment, the interlace combination may be randomly selected by the UE.

In an embodiment, the interlace combination may be selected based on an ID of the UE and the number of available interlace combinations for transmitting the S-SSB(s). For example, an index of the selected interlace combination=UE ID mod the total number of available interlace combinations for transmitting the S-SSB(s).

In an embodiment, the interlace combination may be selected based on a synchronization priority level of the UE. In such embodiment, the definitions regarding synchronization references and synchronization priority levels provided in case 1-1 may also apply here. The UE may obtain another configuration information indicating that each synchronization priority level is mapped to a corresponding interlace combination. The configuration information may be obtained based on configuration, pre-configuration, or pre-definition. The definitions regarding configuration, pre-configuration, or pre-definition as provided above may also apply here. Accordingly, based on the configuration information, the UE may determine an interlace combination corresponding to the synchronization priority level of the UE.

### Case 1-3

In case 1-3, the UE may intend to transmit S-SSB(s) on N3 interlace(s) and SL transmission on N4 interlace(s) within an RB set, wherein N3 and N4 are positive integers. For example, N3 may be determined based on the transmission requirement of the S-SSB, and N4 may be determined based on the transmission requirement of the SL transmission. Then, in step 303, the UE may select an interlace combination from the set of interlace combinations (indicated by the first configuration information) applied for the RB set. The selected interlace combination includes at least N3 interlaces being available for S-SSB transmission and at least N4 interlaces being available for SL transmission.

In an embodiment, the interlace combination may be randomly selected by the UE.

In an embodiment, the interlace combination may be selected based on an ID of the UE and the number of available interlaces for transmitting the S-SSB(s) and the SL transmission. For example, an index of the selected interlace combination=UE ID mod the total number of available interlace combinations for transmitting the S-SSB(s) and the SL transmission.

In an embodiment, the interlace combination may be selected based on a synchronization priority level of the UE. In such embodiment, the definitions regarding synchronization references and synchronization priority levels provided in case 1-1 may also apply here. The UE may obtain another configuration information indicating that each synchronization priority level is mapped to a corresponding interlace combination. The configuration information may be obtained based on configuration, pre-configuration, or pre-definition. The definitions regarding configuration, pre-configuration, or pre-definition as provided above may also apply here. Accordingly, based on the configuration information, the UE may determine an interlace combination corresponding to the synchronization priority level of the UE.

In any one of cases 1-1, 1-2, and 1-3, the UE may perform an LBT to obtain the access opportunity to the RB set based on second configuration information. The UE may obtain the second configuration information based on configuration, pre-configuration, or pre-definition. The definitions regarding configuration, pre-configuration, or pre-definition as provided above may also apply here. The second configuration information may indicate at least one of: a first CPE value for S-SSB transmission (type 1 transmission) and for simultaneous S-SSB transmission and SL transmission within one slot (type 2 transmission); or a first CAPC value for S-SSB transmission and for simultaneous S-SSB transmission and SL transmission within one slot. In some embodiments of the present application, a CPE value may represent a length of a CPE. The CPE may be transmitted by the UE to occupy a channel until the beginning of a target transmission (e.g., at least one of S-SSB transmission or SL transmission) when the channel is determined to be available based on an LBT procedure before the beginning of the target transmission. What is transmitted in the CPE may include a repetition of cyclic prefix (CP) of the first symbol within the target transmission. The only one CPE (or CAPC) value set for the transmissions may achieve same opportunity for the UE to access the RB set for both type 1 and type 2 transmissions. Based on the first CAPC value or the first CPE value, the UE may perform the LBT with an LBT type as described above to obtain the access opportunity to the RB set.

In the case that the UE obtains an access opportunity to the RB set, in step 305, the UE may transmit at least one of the S-SSB(s) or the SL transmission on a set of resources within the resources selected in step 303. For example, in case 1-1, the UE may transmit the S-SSB(s) in the selected N0 interlace(s); in case 1-2, the UE may transmit the S-SSB(s) in N1 interlace(s) within the selected interlace combination; in case 1-3, the UE may transmit the S-SSB(s) in N3 interlace(s) and the SL transmission in N4 interlace(s) within the selected interlace combination.

### Case 2

In case 2, the S-SSB and SL transmissions can be performed by different UEs and have equal opportunity to access the RB set. Given this, the solutions described with respect to cases 1-1, 1-2, and 1-3 may also apply in case 2. In addition, case 2 may further include the case in which the UE may transmit only an SL transmission in the slot where FDM of S-SSB transmission and SL transmission is supported.

As an example, the UE may intend to transmit an SL transmission on N2 interlace(s) within an RB set, wherein N2 is a positive integer. For example, N2 may be determined based on the transmission requirement of the SL transmission. Then, in step 303, the UE may select an interlace combination from the set of interlace combinations (indicated by the first configuration information) applied for the RB set. The selected interlace combination includes at least N2 interlace(s) being available for SL transmission.

In an embodiment, the interlace combination may be randomly selected by the UE.

In an embodiment, the interlace combination may be selected based on an ID of the UE and the number of available interlace combinations for transmitting the SL transmission. For example, an index of the selected interlace combination=UE ID mod the total number of available interlace combinations for transmitting the SL transmission.

In an embodiment, the interlace combination may be selected based on a synchronization priority level of the UE. In such embodiments, the definitions regarding synchronization references and synchronization priority levels provided in case 1-1 may also apply here. The UE may obtain another configuration information indicating that each synchronization priority level is mapped to a corresponding interlace combination. The configuration information may be obtained based on configuration, pre-configuration, or pre-definition. The definitions regarding configuration, pre-configuration, or pre-definition as provided above may also apply here. Accordingly, based on the configuration information, the UE may determine an interlace combination corresponding to the synchronization priority level of the UE.

In case 2, the UE may also perform an LBT to obtain the access opportunity to the RB set based on second configuration information. The UE may obtain the second configuration information based on configuration, pre-configuration, or pre-definition. The definitions regarding configuration, pre-configuration, or pre-definition as provided above may also apply here. The second configuration information may indicate at least one of: a first CPE value for S-SSB transmission (type 1 transmission), for simultaneous S-SSB transmission and SL transmission within one slot (type 2 transmission), and for SL transmission (type 3 transmission); or a first CAPC value for S-SSB transmission, for simultaneous S-SSB transmission and SL transmission within one slot, and for SL transmission. The only one CPE (or CAPC) value set for the transmissions may achieve same opportunity for the UE to access the RB set for all of type 1, type 2, and type 3 transmissions. Based on the first CAPC value or the first CPE value, the UE may perform the LBT with an LBT type as described above to obtain the access opportunity to the RB set.

In the case that the UE obtains an access opportunity to the RB set, in step 305, the UE may transmit at least one of the S-SSB(s) or the SL transmission on a set of resources within the resources selected in step 303. For example, the UE may transmit the SL transmission in N2 interlace(s) within the interlace combination selected in step 303 which includes at least N2 interlace(s) being available for SL transmission.

### Case 3

In case 3, the S-SSB transmission and SL transmission can be performed by different UEs, while the S-SSB transmission has an earlier opportunity than the SL transmission to access the RB set. In other words, case 3 differs from case 2 in that the SL transmission has a lower opportunity to access the RB set, compared to the S-SSB transmission and the simultaneous S-SSB transmission and SL transmission. Given this, all the solutions described with respect to case 2 may also apply in case 3 except for the second configuration information.

In case 3, the second configuration information may indicate at least one of: a first CPE value for S-SSB transmission (type 1 transmission) and for simultaneous S-SSB transmission and SL transmission within one slot (type 2 transmission); or a first CAPC value for S-SSB transmission and for simultaneous S-SSB transmission and SL transmission within one slot. Moreover, the second configuration information may further indicate at least one of: a second CPE value for SL transmission (type 3 transmission), wherein the first CPE value is greater than the second CPE value; or a second CAPC value for SL transmission, wherein the first CAPC value is lower than the second CAPC value.

Accordingly, when the UE intends to transmit S-SSB in the slot or transmit both S-SSB and SL transmission in the slot, the UE may perform an LBT to obtain an access opportunity to the RB set based on the first CPE value or the first CAPC value. When the UE intends to transmit SL transmission in the slot, the UE may perform an LBT to obtain an access opportunity to the RB set based on the second CPE value or the second CAPC value.

In the case that the UE obtains an access opportunity to the RB set, in step 305, the UE may transmit at least one of the S-SSB(s) or the SL transmission on a set of resources within the resources selected in step 303.

According to some other embodiments of the present application, a repetition-based transmission scheme may be applied to S-SSB transmission.

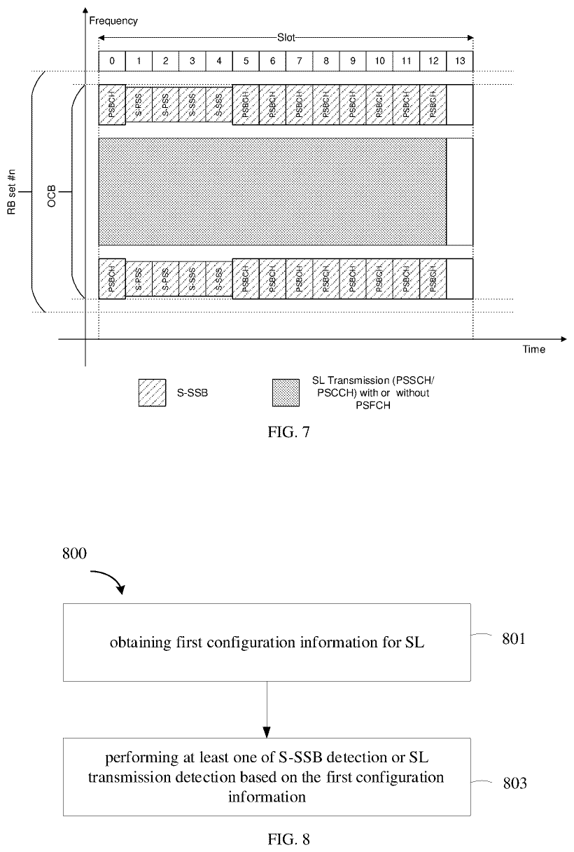

FIG. 7 illustrates exemplary FDM of S-SSB transmission and SL transmission according to some other embodiments of the present application. In the example of FIG. 7, the repetition-based transmission scheme is applied to S-SSB transmission.

Referring to FIG. 7, in the frequency domain, for RB set #n, the S-SSB transmission may meet the OCB requirement due to use of S-SSB repetitions. For example, two repetitions of S-SSB may distribute close to both sides of RB set #n and contiguous RB-based transmission may be applied to each repetition of S-SSB. The remaining resources within RB set #n (e.g., RBs between the two repetitions of S-SSB) may be used for SL transmissions with or without PSFCH. Either interlace RB-based or contiguous RB-based transmission scheme may be applied to SL transmission. In the time domain, the S-SSB and SL transmission may follow any slot structures as specified in 3GPP (e.g., Release 15, Release 16, Release 17, Release 18 and so on) for S-SSB and SL transmission, respectively. For example, the slot structure for S-SSB in FIG. 7 may be the same as that illustrated in FIG. 2. In the frequency domain, the SL transmission may follow the sub-channel based transmission as specified in 3GPP (e.g., Release 15, Release 16, Release 17).

To support the FDM between the S-SSB transmission and SL transmission when the repetition-based transmission scheme is applied to S-SSB transmission, the first configuration information obtained by the UE in step 301 may indicate a first plurality of RBs for S-SSB repetitions in a frequency range, wherein the first plurality of RBs for S-SSB repetitions has a frequency spanning exceeding a predefined percentage of the frequency range. For example, the frequency range may be a BWP, a channel bandwidth, an RB set, etc. For example, the predefined percentage may be 80%. In some examples, the predefined percentage of the frequency range may correspond to the OCB requirement.

In some embodiments, the first configuration information indicating the first plurality of RBs for S-SSB repetitions may indicate: a location of the lowest RB (alternatively referred to as start RB) for each S-SSB repetition and the number of RBs for each S-SSB repetition. The location of the lowest RB and the number of RBs may define a set of RBs (e.g., a set of contiguous RBs) for an S-SSB repetition.

In some embodiments, the first configuration information may further indicate a second plurality of RBs for SL transmission. The second plurality of RBs for SL transmission may locate between the S-SSB repetitions, e.g., between a set of RBs for one S-SSB repetition and a set of RBs for the other SSB repetition. In an embodiment, the first configuration information indicating a second plurality of RBs for SL transmission may indicate a location of the lowest RB (alternatively referred to as start RB) for SL transmission and the number of RBs for SL transmission.

As described above, based on the obtained first configuration information, in step 303, the UE may select resources within an RB set for transmitting at least one of S-SSB(s) or an SL transmission. Then, in step 305, the UE may transmit at least one of the S-SSB(s) or the SL transmission on a set of resources within the selected resources in the case that the UE obtains an access opportunity to the RB set.

When the repetition-based transmission scheme is applied to S-SSB transmission, in a slot, the SL transmission is only permitted to a UE which performs S-SSB transmission within the same slot. That is, the UE may only transmit S-SSB in the slot or transmit both S-SSB and SL transmission in the slot.

In some embodiments, the UE may intend to transmit S-SSB(s), and then the UE may select the first plurality of RBs for S-SSB repetitions for transmitting the S-SSB(s) in step 303.

In some other embodiments, the UE may intend to transmit both S-SSB(s) and SL transmission, and then the UE may select the first plurality of RBs for S-SSB repetitions for transmitting the S-SSB(s) and select a set of RBs within the second plurality of RBs for SL transmission for transmitting the SL transmission in step 303. The set of RBs may be selected based on the transmission requirement of the SL transmission.

In the above embodiments, the UE may perform an LBT to obtain the access opportunity to the RB set based on second configuration information. The UE may obtain the second configuration information based on configuration, pre-configuration, or pre-definition. The definitions regarding configuration, pre-configuration, or pre-definition as provided above may also apply here. The second configuration information may indicate at least one of: a first CPE value for S-SSB transmission (type 1 transmission) and for simultaneous S-SSB transmission and SL transmission within one slot (type 2 transmission); or a first CAPC value for S-SSB transmission and for simultaneous S-SSB transmission and SL transmission within one slot. The only one CPE (or CAPC) value set for the transmissions may achieve same opportunity for the UE to access the RB set for both type 1 and type 2 transmissions. Based on the first CAPC value or the first CPE value, the UE may perform the LBT with an LBT type as described above to obtain the access opportunity to the RB set.

In the case that the UE obtains an access opportunity to the RB set, in step 305, the UE may transmit at least one of the S-SSB(s) or the SL transmission on a set of resources within the resources selected in step 303. For example, in the case that the UE intends to transmit S-SSB(s), the UE may transmit the S-SSB(s) on the first plurality of RBs; in the case that the UE intends to transmit both the S-SSB(s) and the SL transmission, the UE may transmit the S-SSB(s) on the first plurality of RBs and transmit the SL transmission on the selected set of RBs within the second plurality of RBs.

FIG. 8 illustrates a flowchart of an exemplary method 800 for S-SSB transmission and SL transmission according to some other embodiments of the present application. The method 800 illustrated in FIG. 8 may be performed by a UE (e.g., UE 101a or UE 101b in FIG. 1) which intends to receive or detect at least one of S-SSB(s) or an SL transmission or other apparatus with the like functions.

As shown in FIG. 8, in step 801, the UE may obtain first configuration information for SL. For example, the UE may obtain the first configuration information based on configuration, pre-configuration, or pre-definition.

All the definitions regarding configuration, pre-configuration, or pre-definition as provided above may also apply here. All the definitions regarding the first configuration information as provided above may also apply here.

For example, the first configuration information may be determined according to at least one of: BWP, RB set, channel, resource pool, or subcarrier spacing configured for the BWP, RB set, or channel.

For example, the first configuration information may include at least one of:
An interlace pattern, which may indicate the information of interlaces. For example, the information of interlaces may include at least one of: the number of interlaces, indexes of the interlaces, and RBs belonging to or included in each interlace. For example, the interlace pattern may indicate the interlace pattern as shown in FIG. 4.
A set of interlaces for S-SSB transmission, which includes one or more interlaces.
A set of interlace combinations for at least one of S-SSB transmission or SL transmission, wherein each interlace combination includes at least two interlaces. Each interlace in a interlace combination may be available for S-SSB transmission, for SL transmission, or for both S-SSB transmission and SL transmission. Such availability may be implicitly or explicitly indicated to the UE. For example, each interlace within an interlace combination is associated with a transmission type which indicates S-SSB transmission or SL transmission.
A first plurality of RBs for S-SSB repetitions in a frequency range, wherein the first plurality of RBs for S-SSB repetitions has a frequency spanning exceeding a predefined percentage of the frequency range. For example, the frequency range may be a BWP, a channel bandwidth, an RB set, etc. For example, the predefined percentage may be 80%. For example, the first plurality of RBs for S-SSB repetitions may be indicated by a location of the lowest RB for each S-SSB repetition and the number of RBs for each S-SSB repetition.

In step 803, the UE may perform at least one of S-SSB detection or SL transmission (e.g., at least one of PSCCH transmission or PSSCH transmission) detection based on the first configuration information.

According to some embodiments of the present application, an interlace RB-based transmission scheme is applied to S-SSB transmission. In such embodiments, as an example, in the case that the UE intends to receive S-SSB in a slot, the UE may perform S-SSB detection on interlace(s) being available for S-SSB transmission; as another example, in the case that the UE intends to receive SL transmission in a slot, the UE may perform SL transmission detection on interlace(s) being available for SL transmission.

According to some embodiments of the present application, a repetition-based transmission scheme is applied to S-SSB transmission. In some embodiments, the first configuration information may further indicate a second plurality of RBs for SL transmission, wherein the second plurality of RBs for SL transmission locate between the S-SSB repetitions. For example, the first configuration information may also indicate a location of the lowest RB for SL transmission and the number of RBs for SL transmission.

In such embodiments, as an example, in the case that the UE intends to receive S-SSB in a slot, the UE may perform S-SSB detection on the first plurality of RBs for S-SSB repetitions; as another example, in the case that the UE intends to receive SL transmission in a slot, the UE may perform SL transmission detection on the second plurality of RBs for SL transmission.

In some embodiments, the UE may also receive at least one of the second configuration information or the configuration information indicating that each synchronization priority level is mapped to a corresponding interlace or interlace combination, as described in the above embodiments with reference to FIG. 3.

According to some embodiments of the present application, a BS may transmit corresponding configuration information (e.g., at least one of the first configuration information, the second configuration information, or the configuration information indicating that each synchronization priority level is mapped to a corresponding interlace or interlace combination) to one or more UEs (e.g., UE 101a and UE 101b). All the definitions regarding the configuration information as described in the above embodiments with reference to FIG. 3 may also apply here.

In an embodiment, the BS may transmit at least one of the configuration information to one or more UEs via at least one of: a MIB message, a SIB message, an RRC signaling, a MAC CE, or DCI.

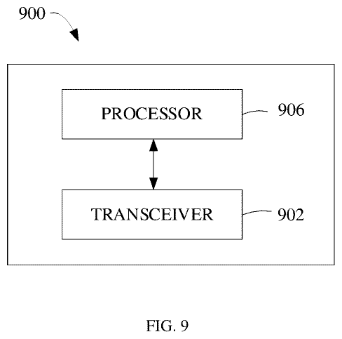

FIG. 9 illustrates a simplified block diagram of an exemplary apparatus 900 for S-SSB transmission and SL transmission in an unlicensed spectrum according to some embodiments of the present application. In some embodiments, the apparatus 900 may be or include at least part of a UE (e.g., UE 101a or UE 101b in FIG. 1). In some other embodiments, the apparatus 900 may be or include at least part of a BS (e.g., BS 102 in FIG. 1).

Referring to FIG. 9, the apparatus 900 may include at least one transceiver 902 and at least one processor 906. The at least one transceiver 902 is coupled to the at least one processor 906.

Although in this figure, elements such as the transceiver 902 and the processor 906 are illustrated in the singular, the plural is contemplated unless a limitation to the singular is explicitly stated. In some embodiments of the present application, the transceiver 902 may be divided into two devices, such as receiving circuitry (or a receiver) and transmitting circuitry (or a transmitter). In some embodiments of the present application, the apparatus 900 may further include an input device, a memory, and/or other components. The transceiver 902 and the processor 906 may be configured to perform any of the methods described herein (e.g., the methods described with respect to FIGS. 2-8 or other methods described in the embodiments of the present application).

According to some embodiments of the present application, the apparatus 900 may be a UE, and the transceiver 902 and the processor 906 may be configured to perform operations of the UE in any of the methods as described with respect to FIGS. 2-7 or other methods described in the embodiments of the present application. For example, the processor 906 is configured to: obtain first configuration information for SL, wherein the first configuration information indicates at least one of the following: an interlace pattern; a set of interlaces for S-SSB transmission; a set of interlace combinations for at least one of S-SSB transmission or SL transmission, wherein each interlace combination includes at least two interlaces; or a first plurality of RBs for S-SSB repetitions in a frequency range, wherein the first plurality of RBs for S-SSB repetitions has a frequency spanning exceeding a predefined percentage of the frequency range; select resources within an RB set for transmitting at least one of S-SSB(s) or an SL transmission based on the first configuration information; and transmit, via the transceiver 902, at least one of the S-SSB(s) or the SL transmission on a set of resources within the selected resources in the case that the UE obtains an access opportunity to the RB set.

According to some embodiments of the present application, the apparatus 900 may be a UE, and the transceiver 902 and the processor 906 may be configured to perform operations of the UE in any of the methods as described with respect to FIG. 8 or other methods described in the embodiments of the present application. For example, the processor 906 is configured to: obtain first configuration information for SL, wherein the first configuration information indicates at least one of the following: an interlace pattern; a set of interlaces for S-SSB transmission; a set of interlace combinations for at least one of S-SSB transmission or SL transmission, wherein each interlace combination includes at least two interlaces; or a first plurality of RBs for S-SSB repetitions in a frequency range, wherein the first plurality of RBs for S-SSB repetitions has a frequency spanning exceeding a predefined percentage of the frequency range; and perform at least one of S-SSB detection or SL transmission detection based on the first configuration information.

According to some embodiments of the present application, the apparatus 900 may be a BS, and the transceiver 902 and the processor 906 may be configured to perform operations of the BS described in the embodiments of the present application. For example, the processor 906 is configured to: transmit, via the transceiver 902, first configuration information for SL, wherein the first configuration information indicates at least one of the following: an interlace pattern; a set of interlaces for S-SSB transmission; a set of interlace combinations for at least one of S-SSB transmission or SL transmission, wherein each interlace combination includes at least two interlaces; or a first plurality of RBs for S-SSB repetitions in a frequency range, wherein the first plurality of RBs for S-SSB repetitions has a frequency spanning exceeding a predefined percentage of the frequency range.

In some embodiments of the present application, the apparatus 900 may further include at least one non-transitory computer-readable medium. In some embodiments of the present disclosure, the non-transitory computer-readable medium may have stored thereon computer-executable instructions to cause the processor 906 to implement any of the methods as described above. For example, the computer-executable instructions, when executed, may cause the processor 906 to interact with the transceiver 902, so as to perform operations of the methods, e.g., as described with respect to FIGS. 2-8 or other methods described in the embodiments of the present application.

The method according to any of the embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for S-SSB transmission and SL transmission, including a processor and a memory. Computer programmable instructions for implementing a method for S-SSB transmission and SL transmission are stored in the memory, and the processor is configured to perform the computer programmable instructions to implement the method for S-SSB transmission and SL transmission. The method for S-SSB transmission and SL transmission may be any method as described in the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for S-SSB transmission and SL transmission according to any embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A user equipment (UE) for wireless communication, comprising:
at least one memory; and
at least one processor coupled to with the at least one memory and configured to cause the UE to:
obtain first configuration information for sidelink (SL), wherein the first configuration information indicates
a first plurality of resource blocks (RBs) for synchronization signal block (S-SSB) repetitions in a frequency range, wherein the first plurality of RBs for S-SSB repetitions has a frequency spanning exceeding a predefined percentage of the frequency range;
select resources within an RB set for transmitting S-SSB(s); and
transmit at least one of the S-SSB(s) in a case that the UE obtains an access opportunity to the RB set.

2. The UE of claim 1, wherein the first configuration information is determined according to one of a bandwidth part (BWP), or the RB set.

3. The UE of claim 1, wherein the first information indicates a set of interlace combinations for S-SSB transmission or SL transmission, and wherein each interlace within an interlace combination is associated with a transmission type which indicates S-SSB transmission or SL transmission.

4. The UE of claim 1, wherein in a case that an interlace RB-based transmission scheme is applied to S-SSB transmission, to select the resources, the at least one processor is configured to cause the UE to at least one of:
in a case that the UE intends to transmit S-SSB(s) on N0 interlace(s), select N0 interlace(s) from a set of interlaces applied for the RB set for transmitting the S-SSB(s), wherein N0 is a positive integer;
in a case that the UE intends to transmit the S-SSB(s) on N1 interlace(s), select an interlace combination from a set of interlace combinations applied for the RB set, wherein N1 is a positive integer, and wherein the selected interlace combination includes at least N1 interlace(s) being available for S-SSB transmission;
in a case that the UE intends to transmit an SL transmission on N2 interlace(s), select an interlace combination from the set of interlace combinations applied for the RB set, wherein N2 is a positive integer, and wherein the selected interlace combination includes at least N2 interlace(s) being available for SL transmission; or
in a case that the UE intends to transmit the S-SSB(s) on N3 interlace(s) and the SL transmission on N4 interlace(s), select an interlace combination from the set of interlace combinations applied for the RB set, wherein N3 and N4 are positive integers, and wherein the selected interlace combination includes at least N3 interlaces being available for S-SSB transmission and at least N4 interlaces being available for SL transmission.

5. The UE of claim 4, wherein the at least one processor is configured to cause the UE to:
randomly select an interlace of the N0 interlace(s), select the interlace based at least in part on an identity (ID) of the UE and a number of available interlaces for transmitting the S-SSB(s), or select the interlace based at least in part on a synchronization priority level of the UE; or
randomly select wherein the interlace combination, select the interlace based at least in part on the ID of the UE and a number of available interlace combinations for transmitting at least one of the S-SSB(s) or the SL transmission, or select the interlace based at least in part on a synchronization priority level of the UE.

6. The UE of claim 1, wherein the first information indicates a set of interlace combinations for S-SSB transmission or SL transmission, and wherein each interlace combination in the set of interlace combinations is determined such that a maximized power per RB achieved by the interlace combination is higher than a maximized power per RB achieved by any other plurality of interlaces having a same number of interlaces as the interlace combination.

7. The UE of claim 1, wherein the first configuration information further indicates a second plurality of RBs for SL transmission, wherein the second plurality of RBs for SL transmission are located between the S-SSB repetitions, and wherein in a case that a repetition-based transmission scheme is applied to S-SSB transmission, to select the resources, the at least one processor is configured to cause the UE to at least one of:
in a case that the UE intends to transmit the S-SSB(s), selecting the first plurality of RBs for S-SSB repetitions for transmitting the S-SSB(s); or
in a case that the UE intends to transmit the S-SSB(s) and the SL transmission, select the first plurality of RBs for S-SSB repetitions for transmitting the S-SSB(s) and select a set of RBs within the second plurality of RBs for SL transmission for transmitting the SL transmission.

8. The UE of claim 1, wherein the first configuration information indicates
a location of a lowest RB for each S-SSB repetition and a number of RBs for each S-SSB repetition.

9. The UE of claim 1, wherein the at least one processor is further configured to cause the UE to:
obtain second configuration information that indicates at least one of:
a first cyclic prefix extension (CPE) value for S-SSB transmission and for simultaneous S-SSB transmission and SL transmission within one slot; or
a first channel access priority class (CAPC) value for S-SSB transmission and for simultaneous S-SSB transmission and SL transmission within one slot; and
perform a listen-before-talk (LBT) to obtain the access opportunity to the RB set based at least in part on the second configuration information.

10. The UE of claim 9, wherein at least one of the first CPE value or the first CAPC value is also used for SL transmission, or the second configuration information further indicates at least one of:
a second CPE value for SL transmission, wherein the first CPE value is greater than the second CPE value; or
a second CAPC value for SL transmission, wherein the first CAPC value is lower than the second CAPC value.

11. A user equipment (UE), comprising:
at least one memory; and
at least one processor coupled to with the at least one memory and configured to cause the UE to:
obtain first configuration information for sidelink (SL), wherein the first configuration information indicates
a first plurality of resource blocks (RBs) for synchronization signal block (S-SSB) repetitions in a frequency range, wherein the first plurality of RBs for S-SSB repetitions has a frequency spanning exceeding a predefined percentage of the frequency range; and
perform S-SSB detection.

12. The UE of claim 11, wherein in a case that an interlace RB-based transmission scheme is applied to S-SSB transmission, to perform at least one of S-SSB detection or SL transmission detection, the at least one processor is configured to cause the UE to at least one of:
in a case that the UE intends to receive S-SSB in a slot, perform S-SSB detection on interlace(s) being available for S-SSB transmission; or
in a case that the UE intends to receive SL transmission in a slot, perform SL transmission detection on interlace(s) being available for SL transmission.

13. The UE of claim 11, wherein the first configuration information further indicates a second plurality of RBs for SL transmission, wherein the second plurality of RBs for SL transmission are located between the S-SSB repetitions, and wherein in a case that a repetition-based transmission scheme is applied to S-SSB transmission, to perform at least one of S-SSB detection or SL transmission detection, the at least one processor is configured to cause the UE to at least one of:
in a case that the UE intends to receive S-SSB in a slot, perform S-SSB detection on the first plurality of RBs for S-SSB repetitions; or
in a case that the UE intends to receive SL transmission in a slot, perform SL transmission detection on the second plurality of RBs for SL transmission.

14. A base station (BS), comprising:
at least one memory; and
at least one processor coupled to with the at least one memory and configured to cause the BS to:
transmit first configuration information for sidelink (SL), wherein the first configuration information indicates
a first plurality of resource blocks (RBs) for synchronization signal block (S-SSB) repetitions in a frequency range, wherein the first plurality of RBs for S-SSB repetitions has a frequency spanning exceeding a predefined percentage of the frequency range.

15. The BS of claim 14, wherein the first configuration information indicates a location of a lowest RB for each S-SSB repetition and a number of RBs for each S-SSB repetition.

16. A method performed by a user equipment (UE), the method comprising:
obtaining first configuration information for sidelink (SL), wherein the first configuration information indicates a first plurality of resource blocks (RBs) for synchronization signal block (S-SSB) repetitions in a frequency range, wherein the first plurality of RBs for S-SSB repetitions has a frequency spanning exceeding a predefined percentage of the frequency range;
selecting resources within an RB set for transmitting of S-SSB(s); and
transmitting at least one of the S-SSB(s) in a case that the UE obtains an access opportunity to the RB set.

17. The method of claim 16, wherein the first configuration information is determined according to one of a bandwidth part (BWP), or the RB set.

18. The method of claim 16, wherein the first configuration information indicates a location of a lowest RB for each S-SSB repetition and a number of RBs for each S-SSB repetition.

19. The method of claim 16, wherein the first information indicates a set of interlace combinations for S-SSB transmission or SL transmission, and wherein each interlace within an interlace combination is associated with a transmission type which indicates S-SSB transmission or SL transmission.

20. The method of claim 16, wherein the first information indicates a set of interlace combinations for S-SSB transmission or SL transmission, and wherein each interlace combination in the set of interlace combinations is determined such that a maximized power per RB achieved by the interlace combination is higher than a maximized power per RB achieved by any other plurality of interlaces having a same number of interlaces as the interlace combination.
